(19) United States
(12) Patent Application Publication
(10) Pub. No.: US 2007/0029423 A1
(43) Pub. Date: Feb. 8, 2007

(54) Crusher

(75) Inventors: Haruo Sanagi, Ikoma-shi (JP); Akihiro Ochiai, Ikoma-shi (JP); Tsutomu Murata, Osaka-shi (JP)

Correspondence Address: KNOBBE MARTENS OLSON & BEAR LLP, 2040 MAIN STREET, FOURTEENTH FLOOR, IRVINE, CA, 92614, US

(73) Assignee: SIGMA SEIKO CO., LTD., IKOMA-SHI, NARA (JP)

(21) Appl. No.: 10/547,858

(22) PCT Filed: Mar. 4, 2004
(86) PCT No.: PCT/JP04/02744

§ 371 Date: Jun. 29, 2006

(30) Foreign Application Priority Data
Mar. 4, 2003 (JP) 2003-056788

(51) Int. Cl. B02C 7/04

(52) U.S. Cl. 241/261.2

(57) ABSTRACT

The present invention provides a crusher that is capable of crushing material such as waste rubber material under the conditions of room temperature without causing heating due to excessive friction, etc. The crusher of the invention comprises a pair of crushing panels, each crushing panel having crushing blades on the face opposing the other crushing panel; a charging port for charging material to be crushed into a space where the crushing panels oppose each other, the charging port being formed near the center of one of the crushing panels; and a driving part for rotating at least one of the crushing panels; wherein the angle formed by the pair of the crushing panels is smaller on the circumference side of the opposing faces of the crushing panels than on the central side of the opposing faces of the crushing panels.

### TECHNICAL FIELD

The present invention relates to a crusher, and particularly to a crusher that is suitable for crushing elastic and combustible materials such as waste rubber materials, typically waste tires of automobiles or the like.

### BACKGROUND ART

In recent years, technologies have been developed to recycle waste rubber materials as new rubber products or to use them as fuels, wherein such waste rubber materials are, for example, waste tires or remnants resulting from the production processes of rubber products such as a shoe sole component punched out from rubber sheets. For example, rubber powders crushed to sizes below a particular level can be reused for rubber soles of shoes, beach sandals, tire extenders, parts of asphalt pavement materials, etc. In order to perform such reuses, it is necessary to crush waste rubber materials to extremely fine powders. For example, when used for the rubber soles of shoes, the rubber powder particle must be about 0.4 mm per side, and when used for tire (made of raw rubber) extenders, etc., they must be about 0.2 mm per side.

Examples of devices that crush waste rubber materials to such sizes include rotating-drum crushing devices, etc. However, crushing at room temperature is difficult in such devices. Therefore, it is usual to create a low-temperature environment by pouring liquid nitrogen into a drum, etc., and freeze the waste rubber materials before crushing them.

As Japanese Unexamined Patent Publication No. 1999-104510 discloses, a rotating-drum crusher 40 as shown in FIG. 18 is a known rubber crusher. In such a crusher, a waste rubber material (waste tire chips) that has been crushed to a predetermined size (about 10-20 cm per side) at room temperature is put into the drum 40. A refrigerant such as liquid nitrogen is then poured into the drum 40 to create a low-temperature environment of about −40° C. to about −60° C. in the drum 40. The rubber chips thus frozen are crushed more finely (to about 1 mm per side) by means such as hammer mills, etc.

However, when such a crusher for waste rubber material is used, the inside of the crusher must be constantly cooled using liquid nitrogen, etc. so that the waste rubber material is frozen. Therefore, when a large amount of waste rubber materials are crushed for the recycling of rubber materials, there are problems such as excessively large-scale devices, prolonged crushing time, enormous amounts of labor and costs for the supply of liquid nitrogen, etc. Furthermore, there is another disadvantage in that when the waste rubber materials are frozen, the physical properties thereof are changed and the uses thereof in recycling are limited.

In contrast, for example, Japanese Unexamined Patent Publication No. 1997-253515 discloses a grinder (flour mill) for grinding down grain into powder, etc., wherein a pair of upper and lower disk-shaped grinding boards is provided on a rotary shaft that is rotated by driving means such as a motor, etc., with opposing grinding grooves being formed as grinding blades. In such a grinder, the objects (grain, etc.) to be ground, which are supplied between the grinding boards, are ground to sizes below a particular level by rotating the grinding boards together with the rotary shaft. The above grinding grooves are formed in mortar grinding surface patterns. They gradually grind the objects to be ground while moving the ground objects outward (toward the circumference of the grinding boards) by centrifugal force and extrusive force.

However, when such a grinder is used to grind an elastic material to be ground such as a waste rubber material, the rubber powder obtained by grinding is relatively large (about 1.0-3.0 mm per side) and does not reach the size required for recycling as a rubber material (about 0.2-0.4 mm per side). Furthermore, when such a grinder is used for grinding more finely, the rubber material to be ground cannot be suitably ground since the rubber material is deformed due to its own elasticity in the process of being ground, thus discharged without being ground.

As shown in FIG. 19, when the space between the grinding boards is narrowed linearly, the material (rubber material) X to be ground is discharged while being deformed in the grinding direction according to the angle between the grinding blades 200a and 210a formed on the grinding boards 200 and 210, respectively. The rubber material thus discharged while being deformed is much larger than the desired size (0.2-0.4 mm).

### DISCLOSURE OF THE INVENTION

In order to solve the above-mentioned problems, the present invention provides, in claim 1, a crusher comprising a pair of crushing panels, each crushing panel having crushing blades on the face opposing the other crushing panel; a charging port for charging material to be crushed into a space where the crushing panels oppose each other, the charging port being formed near the center of one of the crushing panels; and a driving part for rotating at least one of the crushing panels; wherein the crushing blades are formed such that the material is crushed and pushed from the crushing panels by rotation of at least one of the crushing panels; and the angle formed by the pair of the crushing panels is smaller on the circumference side of the opposing faces of the crushing panels than on the central side of the opposing faces of the crushing panels. In such a crusher, when the material to be crushed has been crushed to a particular size, the pressure from the crushing panel is made less intense, thus weakening the force applied to the material and reducing deformation. In this manner, the crusher of the invention is capable of suitably crushing elastic materials.

In claim 2, the present invention provides such a crusher wherein the angle formed by the pair of the crushing panels is smaller on the circumference side of the opposing faces of the crushing panels than on the central side of the opposing faces of the crushing panels, in that, based on a concentric circular boundary formed on the opposing faces of the crushing panels, the above angle is smaller on the outer side of the boundary than on the inner side of the boundary. This crusher achieves the above-mentioned effects by forming the crushing blade-side surfaces of the crushing panels in a simple manner. That is, suitable crushing can be easily performed by merely adjusting the above-mentioned angle formed by the crushing panels according to conditions such as the characteristics of materials to be crushed, the desired size of crushed materials, crushing speed, etc.

In the crusher wherein the angle formed by the crushing panels differs between the inner side and the outer side of the boundary as mentioned above, the number of crushing blades in the crushing panels may differ between the inner side and the outer side of the boundary (claim 3). This enables changing the number of times that the material that has been crushed to a particular size is crushed by the crushing blades, thereby making adjustments such that the material is crushed to a suitable size.

On the outer side of the boundary, the opposing faces of the pair of the crushing panels may be substantially parallel to each other (claim 4). When the opposing faces of the pair of the crushing panels are parallel, elastic materials such as rubber materials can be properly crushed, minimizing deformation.

A passage for liquid may be provided within the crushing panels such that the frictional heat generated in the crushing blades is minimized by passing liquid such as cooling water (claim 5). Specifically, it is preferable to circulate liquid such as cooling water such that the liquid is supplied from outside the crushing panels, passed through the passage, and then discharged from the crushing panels.

When the crushing blades are not sufficiently cooled by radiating heat from the external surfaces of the crushing panels through air, etc., the crushing blades can be effectively cooled in the above manner. This is effective in preventing the material to be crushed from becoming soft and easy to bend (easy to deform) due to an excess of frictional heat.

Preferably, the crushing blades on the opposing crushing panels are formed by parallel grooves such that the parallel grooves of the opposing crushing panels cross each other.

Preferably, the parallel grooves of the crushing blades are formed in segments that equally divide the crushing panels.

Preferably, the crushing blades comprise areas where the parallel grooves have rectangular cross sections and areas where the parallel grooves have saw-toothed cross sections; and preferably, the parallel grooves having saw-toothed cross sections are formed on the central side of the crushing panels.

Preferably, on the central side of the crushing panels, the crushing blades have heights such that the space between the opposing crushing panels gradually narrows toward the circumference of the crushing panels.

### BRIEF DESCRIPTION OF THE DRAWINGS

FIG. 1 is a longitudinal sectional view showing the main parts of a crusher according to the first embodiment of the present invention.

FIG. 2 is an enlarged sectional view showing the crushing blade faces of crushing panels according to the first embodiment of the present invention.

FIG. 3 is a plan view showing the shape of the blades of the crushing panels of FIG. 1.

FIG. 4 is a longitudinal sectional view showing the main parts of a crusher according to the second embodiment of the present invention.

FIG. 5 is an enlarged sectional view showing the crushing blade faces of crushing panels according to the second embodiment of the present invention.

FIG. 6 is a plan view showing the shape, etc. of the crushing blades formed on the crushing blade faces of crushing panels according to the second embodiment of the present invention.

FIG. 7 is a sectional view showing the shape, etc. of crushing blades formed on the crushing blade face of a crushing panel according to the second embodiment of the present invention.

FIG. 8 is a plan view showing another shape, etc. of the crushing blades formed on the crushing blade faces of crushing panels according to the second embodiment of the present invention.

FIG. 9 is a plan view showing a lower crushing panel according to the third embodiment of the present invention.

FIG. 10 is a plan view showing an upper crushing panel according to the third embodiment of the present invention.

FIG. 11 shows an enlarged view of a part of FIG. 9, with (a) being a plan view, (b) being an A-front view, and (c) being a partially enlarged longitudinal sectional view.

FIG. 12 shows a partially omitted plan view of FIG. 10.

FIG. 13 shows an enlarged view of a part of FIG. 10, with (a) being a plan view, (b) being a B-side view, and (c) being a perspective view from an oblique bottom in the direction of A.

FIG. 14 shows an enlarged view of a part of FIG. 10, with (a) being a plan view, (b) being a B-side view, and (c) being a perspective view from an oblique bottom in the direction of A.

FIG. 15 shows an enlarged view of a part of FIG. 10, with (a) being a plan view, (b) being a B-side view, and (c) being a perspective view from an oblique bottom in the direction of A.

FIG. 16 shows the segments of FIG. 13 to FIG. 15 disposed side by side, with (a) being a plan view and (b) being a perspective view from an oblique bottom in the direction of A.

FIG. 17 is a longitudinal sectional view showing the main parts of a crusher according to the fourth embodiment of the present invention.

FIG. 18 is a perspective view schematically showing the whole of a conventional crusher.

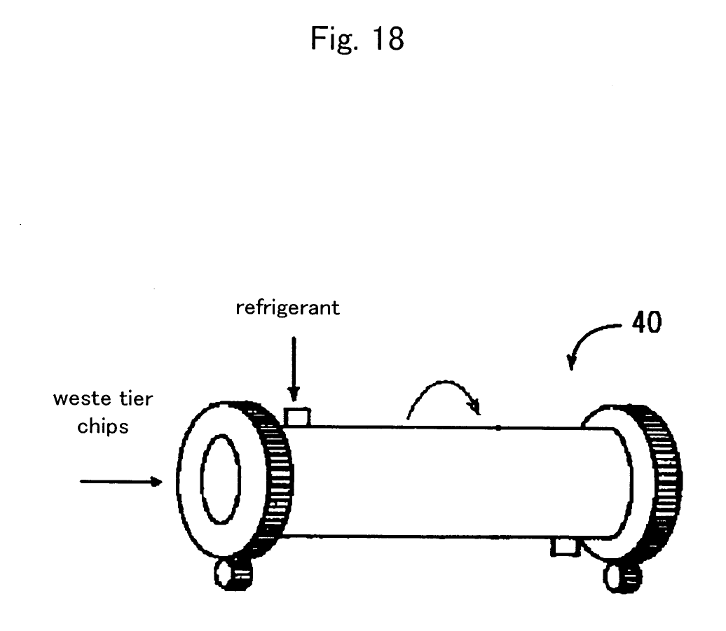

FIG. 19 is a longitudinal sectional view showing an elastic body deformed by a conventional crusher used to crush it.

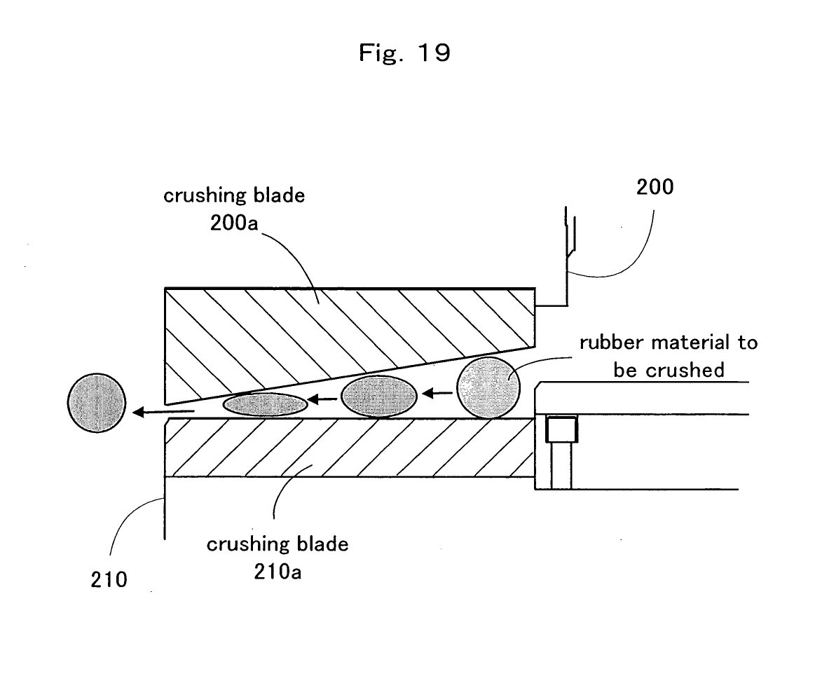

### BEST MODE FOR CARRYING OUT THE INVENTION

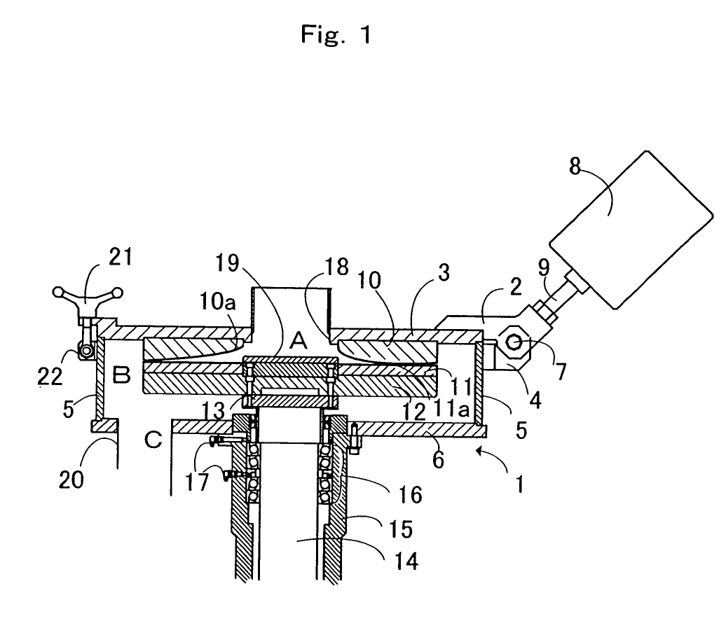

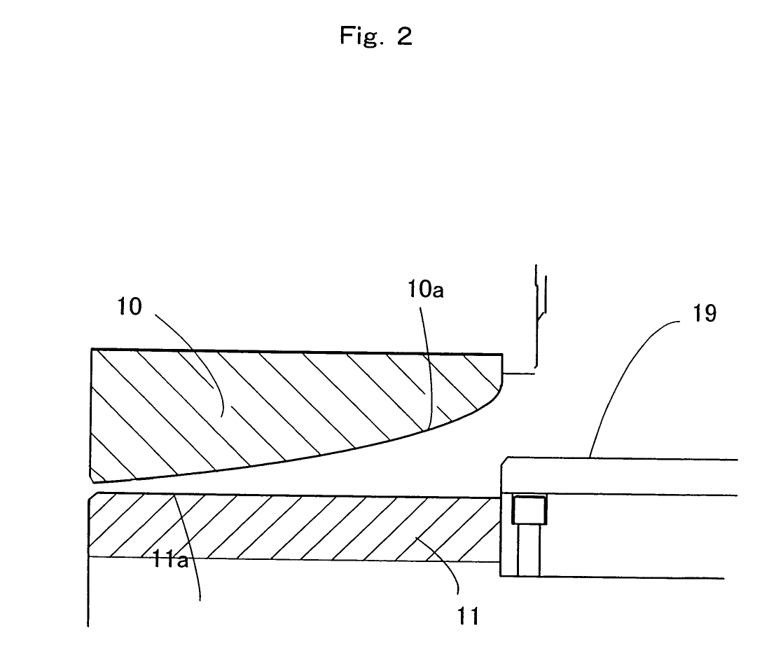

Preferable embodiments of the present invention are described below with reference to the drawings. FIGS. 1 and 2 show the first embodiment of the present invention. The elements represented by the same symbols in the drawings have similar or the same structures, which provide similar or the same functions and effects.

In crusher body 1, upper cover 3, which is fixed to upper holder 2 by welding, bolting, or the like, and case 5 and lower cover 6, which are similarly fixed to lower holder 4, are structured so as to open and close freely by hinge 7. Upper holder 2 and lower holder 4 are connected to weight-adjusted balance weight 8 via handle 9 such that, when opened to a particular position, upper cover 3 does not close itself due to its own weight. Disk-shaped upper crushing panel 10 (diameter: about 500 mm) formed of materials such as carbon steel (for example, SKD-11), etc. is fixed to the lower side of the upper cover by means of bolts, etc. In this embodiment, upper crushing panel 10 has crushing blade face 10a, which has a gently curved surface. The curved surface may be suitably selected from shapes such as sphere, paraboloid, ellipsoid, etc.

Disk-shaped lower crushing panel 11 formed of similar materials is disposed opposite the above-mentioned upper crushing panel 10. Lower crushing panel 11 is fixed to turntable 12 by means of bolts, etc. Turntable 12 is connected to rotating shaft 14 via connecting part 13. Rotating shaft 14 is rotated by rotation drive from a driving part (not shown), thus rotating turntable 12 together with lower crushing panel 11. In this embodiment, lower crushing blade face 11a of lower crushing panel 11 is roughly horizontal.

Rotating shaft 14 is structured such that it rotates inside column part 15, which is fixed to lower cover 6 by bolts, etc. Therefore, in column part 15, ball bearing 16 is formed so as to be in contact with rotating shaft 14, and inlet 17 for suitably supplying lubricating oil to ball bearing 16 is formed through column part 15.

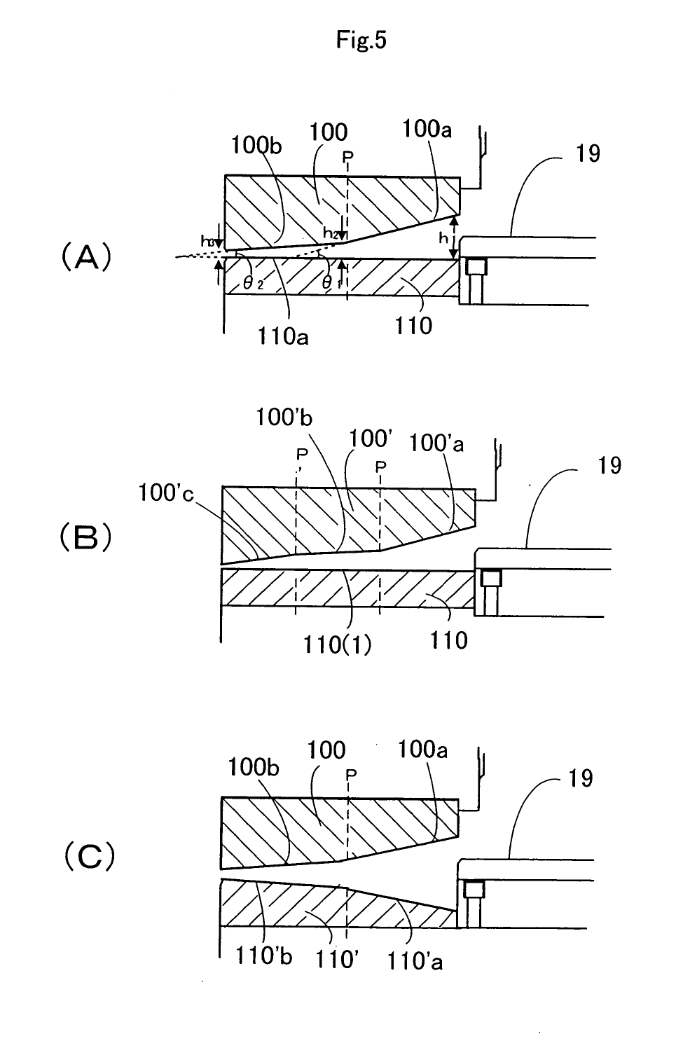

Charging port 18 for charging material to be crushed inside is formed near the center of upper cover 3 and upper crushing panel 10. The material to be crushed is carried by supply means (not shown) such as vibrating feeder, screw conveyor, or the like, and then charged into charge space A of charging port 18. The material to be crushed that has been charged inside is then guided into the space between upper crushing panel 10 and lower crushing panel 11 by guide means 19, which is fixed roughly right under charging port 18 by bolts, etc. Although guide means 19 may be in the form of a smooth slope that does not rotate, it may have a vane structure in which, as shown in FIG. 5, etc., the guide means fixed to rotating shaft 14 is rotated such that the material to be crushed is guided outward by centrifugal force. It is not necessary to carry out synchronous rotation of guide means 19 with rotating shaft 14, and the rotating speed of guide means 19 may be changed. In this manner, the amount of material to be guided may be made adjustable, and the amount of powders to be finally generated can be adjusted.

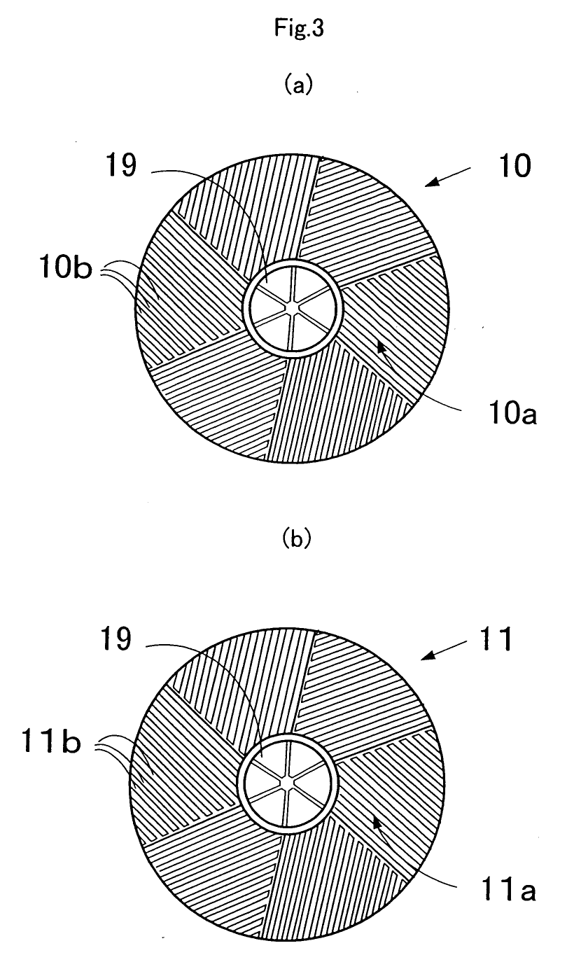

FIG. 2 is an enlarged view showing a cross section of upper crushing panel 10 and lower crushing panel 11 according to the first embodiment shown in FIG. 1. In FIG. 2, crushing blade face 10a of upper crushing panel 10 is in the form of a smooth curved surface such as sphere, ellipsoid, paraboloid, etc., and this curved surface is provided with crushing blades (not shown). Therefore, the angle formed by crushing panels 10 and 11 becomes gradually smaller as it goes farther away from the central side of the crushing panels to the outer side (circumference side) thereof. That is, the angle formed by crushing panels 10 and 11 is smaller on the circumference side of the opposing faces of the crushing panels than on the central side of the opposing faces of the crushing panels. Upper crushing panel 10 and lower crushing panel 11 are substantially parallel near the circumference thereof, with the gap between the upper and lower crushing panels being about 0.1 to about 0.2 mm. As shown in FIG. 3 as a plan view, crushing blades 10b and 11b of crushing blade faces 10a and 11a are formed in each of the six segments 10-1 to 10-6 and 11-1 to 11-6, which equally divide upper crushing panel 10 and lower crushing panel 11 with respect to the central angles thereof. Each of the segments 10-1 to 10-6 and 11-1 to 11-6 is a roughly fan-shaped plate and is fixed to upper cover 3 or lower cover 6 by bolts (not shown), etc. When upper crushing panel 10 and lower crushing panel 11 are large in size, the processing and exchange of crushing blades is facilitated by forming the crushing blades segment by segment in this manner.

Crushing blades 10b and 11b can be formed by parallel grooves, which are formed in each segment. The parallel grooves of crushing blades 10b and 11b are formed such that, when the crushing panels are opposed to each other, the opposing crushing blades 10b and 11b cross each other. In the examples shown in the drawings, the parallel grooves formed in each segment have mortar grinding patterns as a whole, and crushing blade 10b of upper crushing panel 10 and crushing blade 11b of lower crushing panel 11 are of the same shape. Crushing blades 10b and 11b may have rectangular cross sections.

When crushing blades are formed by the above parallel grooves, lower crushing panel 11 works in cooperation with the crushing blades of upper crushing panel 10, shearing the material to be crushed and pushing out the crushed material toward the circumference side of the crushing panels.

Furthermore, when the angle formed by crushing panels 10 and 11 is as mentioned above, the material to be crushed is pushed outward and crushed by the crushing panels while the pressure from the crushing panels is gradually reduced. As a result, the deformation of the material to be crushed is minimized, and crushing is thus carried out in a suitable manner.

The material to be crushed that is guided into the space between upper crushing panel 10 and lower crushing panel 11 is gradually crushed finely by crushing blade faces 10a and 11a. With the rotation of the crushing panel, the material is moved toward the circumference side of the crushing component by centrifugal force and the extrusive force of each blade face, and finally pushed out into discharge space B. The powders (crushed materials) that have been pushed out into discharge space B are drawn to discharge port C by drawing means (not shown) such as blower, discharged via discharge part 20, and suitably stored in a container (not shown).

As long as discharge part 20 is formed near discharge space B, into which the powders are pushed out, the position of discharge part 20 is not limited to lower cover 6. For example, when the drawing means has sufficient drawing force, discharge part 20 may be formed above discharge space B. That is, discharge part 20 may be positioned anywhere near discharge space B in consideration of the location of the container for storing powders, the whole structure of crusher body, etc.

Powders (crushed materials) may not be properly discharged on account of reduced pressure in the space in case 5 caused by the above-mentioned drawing means (not shown). It is therefore preferable to form an airflow inlet for supplying air into case 5. The flow of air is thereby generated in case 5, and the powders (crushed materials) are then suitably discharged.

Element 21 is a clamp screw, which securely fixes upper cover 3 to case 5 (or lower cover 6) and has a handle so that the screw can be tightened by hand or machine. Element 22 is a screw stop, which is provided on the side of case 5 and engages with clamp screw 21.

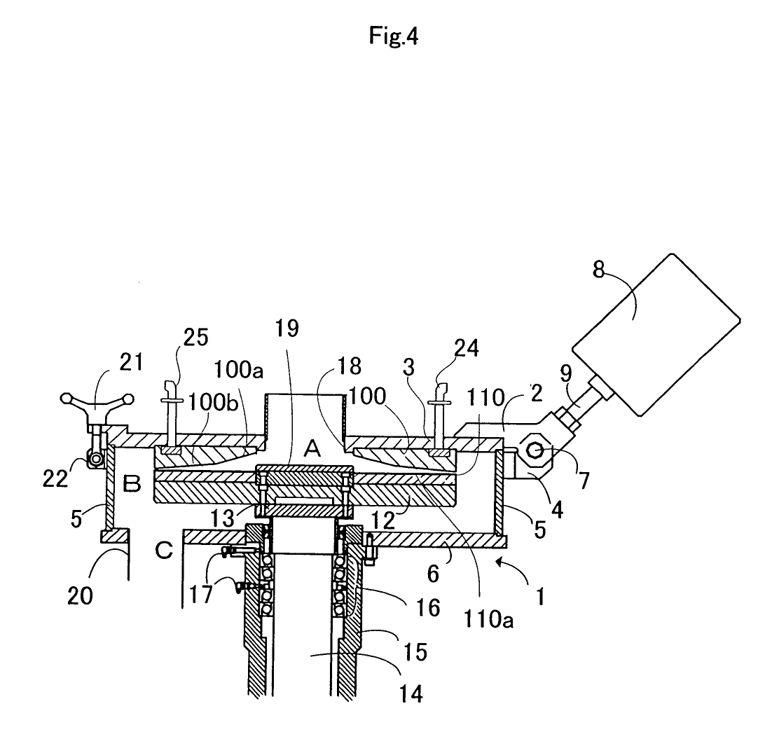

Next, the second embodiment of the present invention is described with reference to FIGS. 4 and 5. In FIG. 3, the same symbols are used to refer to the elements having the same structures as those in the first embodiment in FIG. 1.

In the second embodiment in FIG. 4, upper crushing panel 100 comprises first crushing blade face 100a, which is formed at a predetermined angle, and second crushing blade face 100b, which continues from first crushing blade face 100a at concentric circular boundary P and is formed at an angle different from the above predetermined angle.

Passage 23 for passing cooling water is provided within upper crushing panel 100. Passage 23 is preferably provided on the circumference side of crushing panel 100, where intense frictional heat is generated at the time of crushing. The cooling water supplied from water supply part 24, which is connected to passage 23, is circulated within crushing panel 100 to cool crushing panel 100 and crushing blade face 100a, and then discharged outside via water discharge part 25.

In FIG. 5, the passage for circulating cooling water is provided only in upper crushing panel 100, which is a fixed crushing panel. However, the present invention is not limited to this. A similar passage may be provided in a rotating lower crushing panel.

FIG. 5 (A) is an enlarged view showing upper crushing panel 100 and the lower crushing panel according to the embodiment shown in FIG. 4. As shown in FIG. 5 (A), the angle θ₁ formed by first crushing blade face 100a and crushing blade face 110a is greater than the angle θ₂ formed by second crushing blade face 100b and crushing blade face 110a of lower crushing panel 110.

The angles θ₁ and θ₂ are determined by the distance between the upper crushing panel and the lower crushing panel, the length of the crushing blade face in the radial direction, the number and shape of the crushing blades, etc. As shown in FIG. 4 (A), a preferable design for this embodiment is as follows: gap h₁ at the beginning of the crushing space=about 10-15 mm, gap h₂ at boundary P of the crushing space=about 0.1-0.3 mm, and gap h₃ at the end of the crushing space=about 0.1-0.2 mm. In particular, gap h₃ is an important factor in determining the size of the powder obtained as the final product. In this example, horizontal length L₁ of first crushing blade face 100a is designed to be about 150 mm, and horizontal length L₂ of second crushing blade face 100b is designed to be about 50 mm.

In this embodiment, the shapes of the upper crushing panel and the lower crushing panel are not limited to those shown in FIG. 5 (A). As shown in FIG. 5 (B), for example, the above-mentioned angles may be changed into three (or more) levels by providing concentric circular boundaries P and P′. This requires that the farther outward in the radial direction the crushing blade face is, the smaller the angle formed by the upper crushing blade face and the crushing blade face of the lower crushing panel is.

In addition to forming multileveled crushing blade face angles of the upper crushing panel, the crushing blade face angles of lower crushing panel 110 may be multileveled as in 110′a and 110′b of FIG. 5 (C). This modification requires that the farther outward in the radial direction the crushing blade face is, the smaller the angle formed by the corresponding crushing blade faces (such as the angle formed by 100a and 110′a) is.

When the crushing blade faces of the upper crushing panel and the lower crushing panel are parallel to each other, the angle formed by these blade faces is regarded as θ=0°. For example, in FIG. 5 (A), first crushing blade face 100b of the upper crushing panel may be formed so as to be parallel to crushing blade face 110 of the lower crushing panel, if necessary. This minimizes the deformation of the material to be crushed, thus leading to suitable crushing.

As described above, when the angle formed by the upper and lower crushing blade faces is designed to be gradually smaller toward the outside (circumference side) of the crushing panel, it is possible to prevent elastic materials to be crushed from being discharged from the crusher in a deformed state due to elasticity (without being crushed to the desired size).

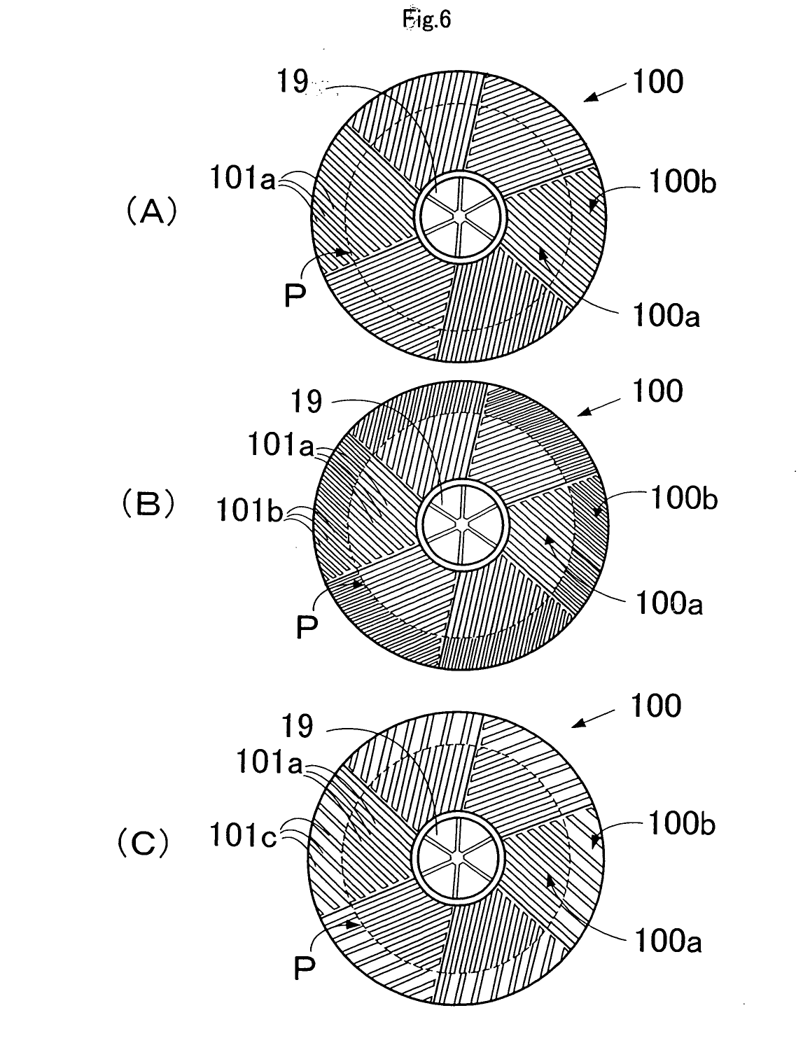

FIG. 6 shows the inner side (side having blade surface) of the crushing blade face according to this embodiment. The blade face inside concentric circular boundary P expressed by the broken line in FIG. 6 is first crushing blade face 100a of upper crushing panel 100 in FIGS. 4 and 5 (A), and the blade face outside the boundary is second crushing blade face 100b. Here, first crushing blade face 100a and second crushing blade face 100b may be independently constituted or integrally constituted.

As shown in FIGS. 6 (B) and (C), the number of blades formed on the crushing blade faces may differ between first crushing blade face 10a and second crushing blade face 100b. For example, when the angle formed by second crushing blade face 100b and crushing blade face 110a of lower crushing panel 110 is sufficiently small, the number of blades (101b) formed on second crushing blade face 100b may be greater than the number of blades (101a) formed on first crushing blade face 100a as shown in FIG. 6 (B), such that crushing is performed efficiently.

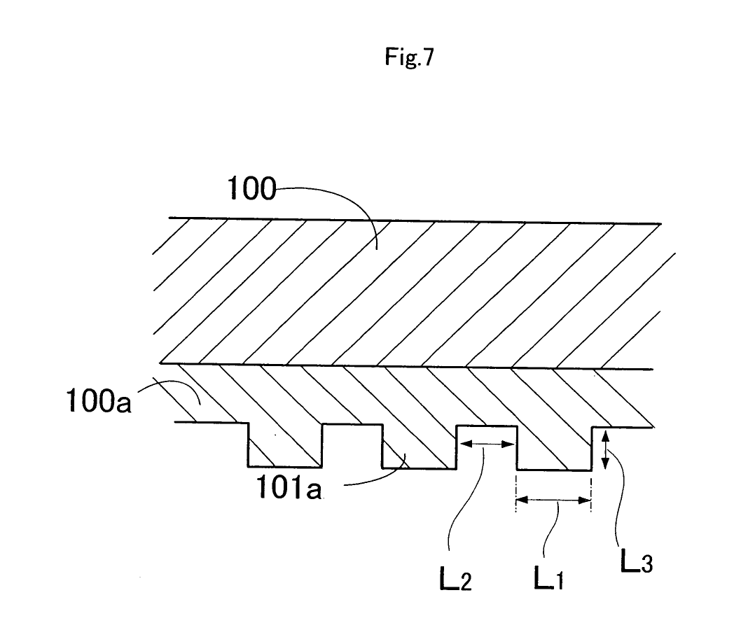

In contrast, when the angle formed by second crushing blade face 100b and crushing blade face 110a of lower crushing panel 110 is substantially as great as the angle formed by first crushing blade face 100a and crushing blade face 110a, the number of blades (101c) formed on second crushing blade face 100b may be somewhat decreased. This reduces the friction generated in crushing to some extent, leading to suitable crushing (see FIG. 6 (C)). Here, the crushing blades may have rectangular cross sections as shown in FIG. 7, for example, or may have other shapes widely used for crushing or breaking. In the example shown in FIG. 7, a preferable design for the size of crushing blade 101a is as follows: blade width L1=about 5.0 mm, groove width L2=about 5.0 mm, and groove depth L3=about 0.4-0.7 mm. Furthermore, when the gap (crushing space) between the edge of the crushing blade of the crushing blade face (the first crushing blade face) in FIG. 7 and that of the crushing blade of the other crushing blade face (second crushing blade face side) is maintained at a distance of about 0.1 mm, materials can be crushed to the desired size.

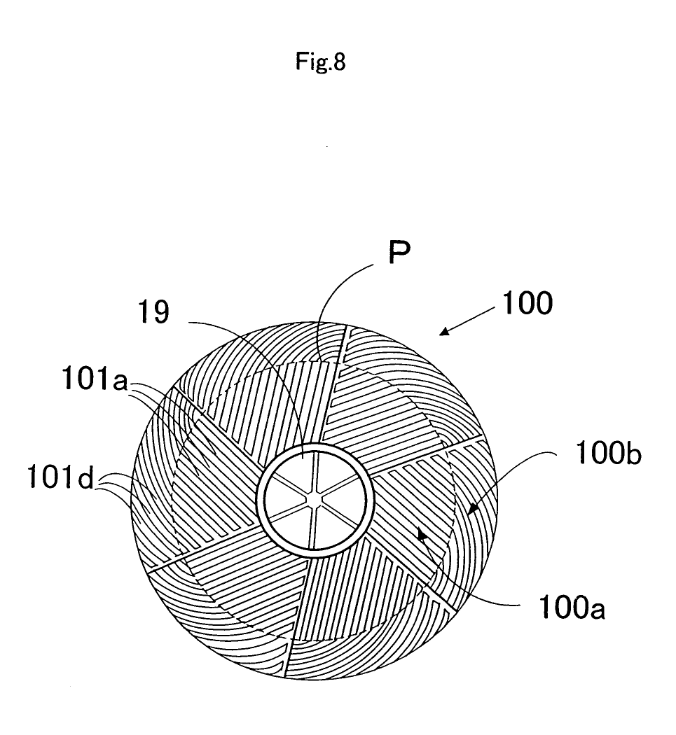

In this embodiment, it is effective to form different kinds of blades for the first crushing blade face and the second crushing blade face, i.e., to use blades that differ in number, shape, etc. between the two blade faces. As shown in FIG. 8, for example, the kind of blade (101d) formed on second crushing blade face 101b may be changed from a straight blade to a curved one. In this embodiment, the angle formed by the first crushing blade face and the crushing blade face of the lower crushing panel may be the same as or different from the angle formed by the second crushing blade face and the crushing blade face of the lower crushing panel. It is preferable to select a suitable angle, depending on the amount of materials to be crushed, the characteristics of the materials, and other conditions.

In the examples shown in FIGS. 6 and 8, crushing blade faces (100a, etc.) are formed by cutting grooves such that mortar surface patterns (grinding patterns) are formed in the body of the crushing panel. The upper crushing panel and the lower crushing panel may have crushing blade faces of the same shape. In this case, the crushing blade faces of the opposing crushing panels cross each other, thereby enhancing the effect of pushing the crushed material out from the crushing panels.

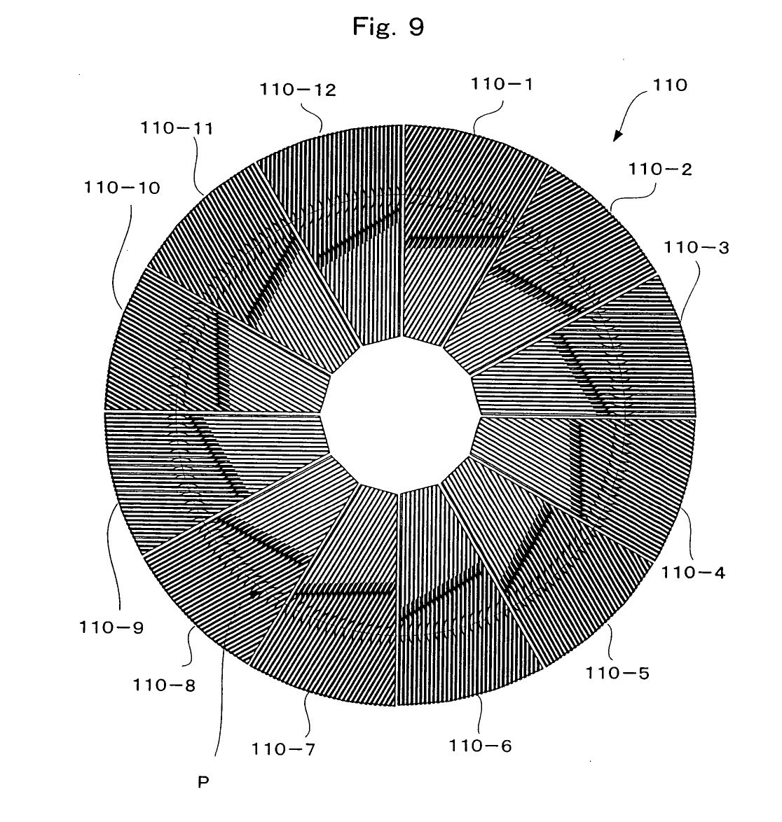

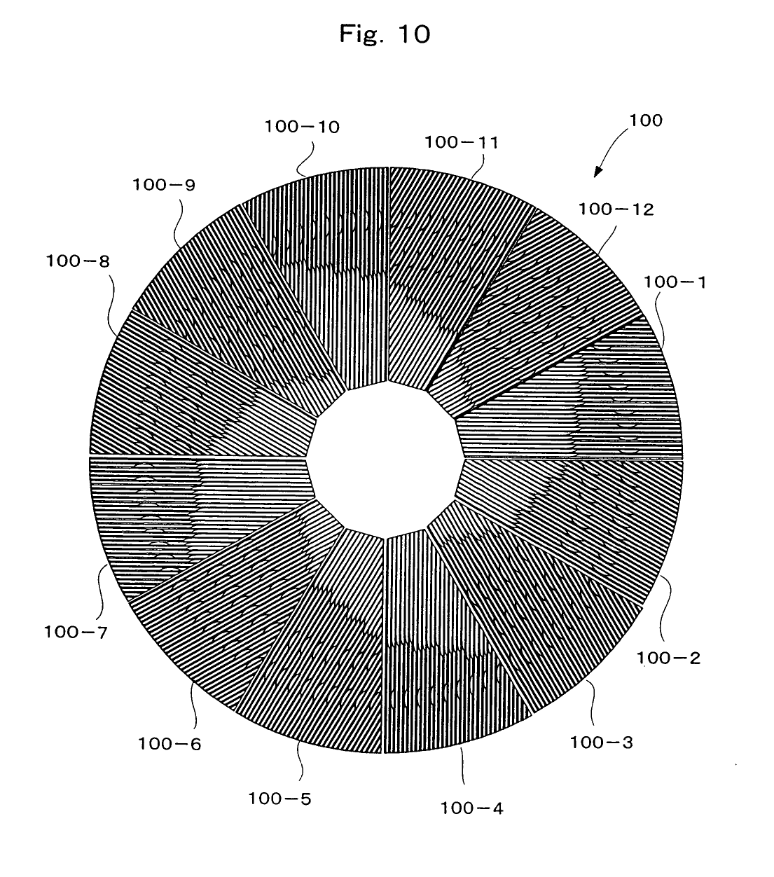

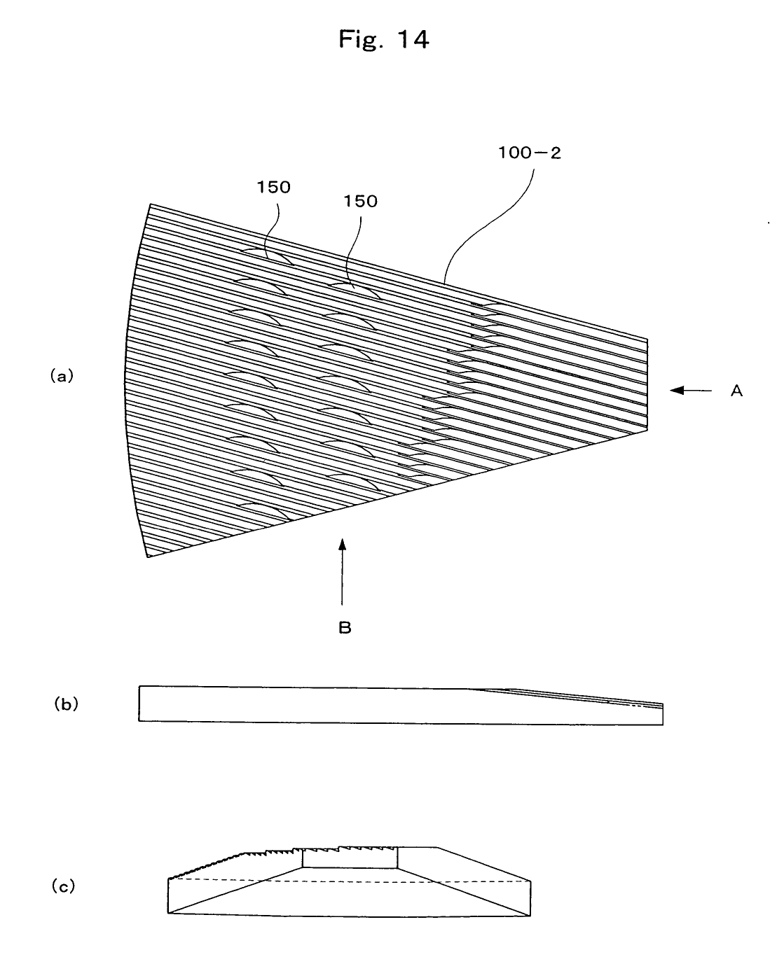

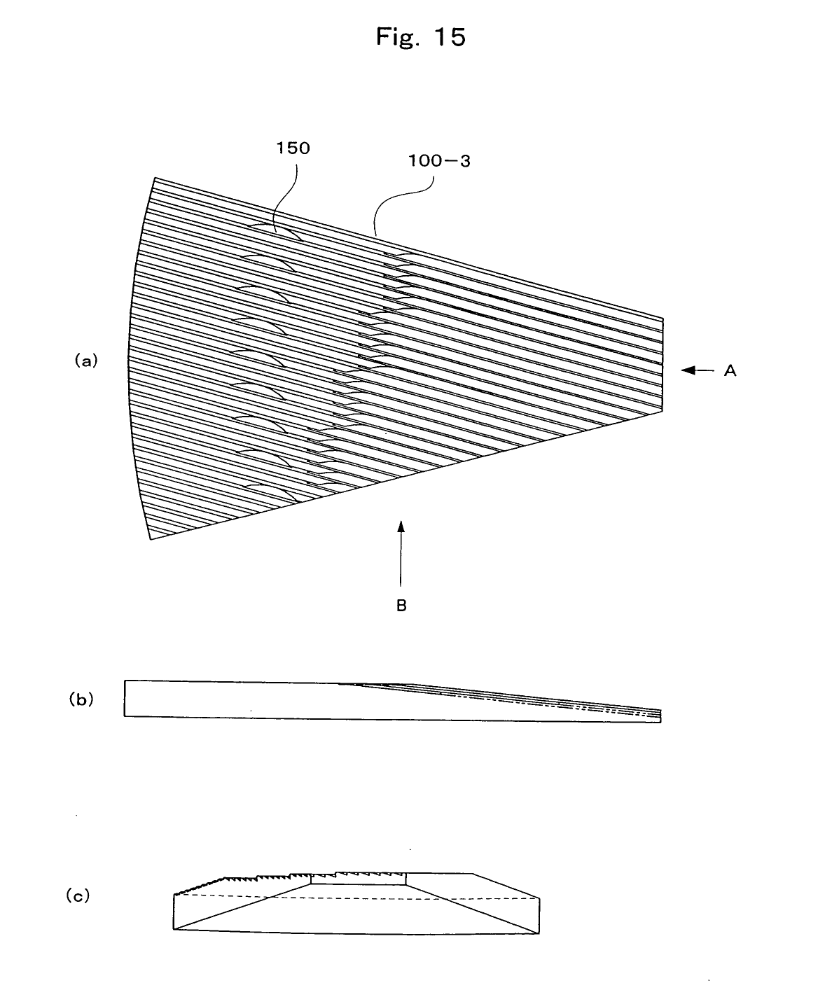

Next, the third embodiment of the crusher of the present invention is described with reference to FIGS. 9-15. The third embodiment differs from the second embodiment in the shape of crushing blade and is the same as the second embodiment in other respects. FIG. 9 is a plan view showing a lower crushing panel according to the third embodiment. FIG. 10 is a plan view showing an upper crushing panel according to the third embodiment.

As shown in FIGS. 9 and 10, crushing panels 110 and 100 are formed by 12 segments, which equally divide each crushing panel. Segments 110-1 to 110-12 of lower crushing panel 110 have crushing blades of the same shape.

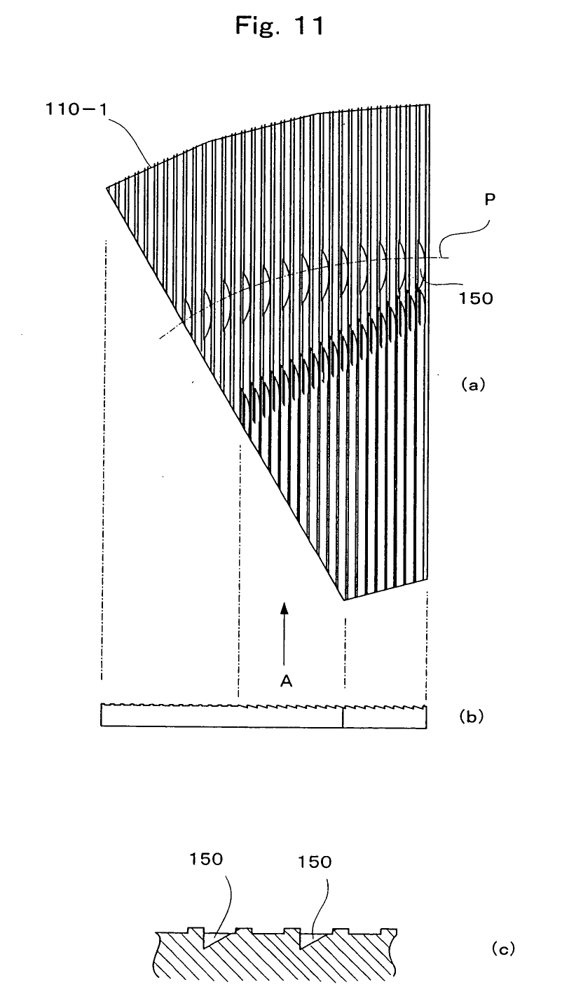

For example, an enlarged view of segment 110-1 of the lower crushing panel is shown in FIG. 11. FIG. 11 (a) is a plan view, and FIG. 11 (b) is a front view seen in the direction of A of FIG. 11 (a). As shown in FIG. 11 (b), the parallel grooves that form crushing blades in the area from the inner side to a roughly middle part have saw-toothed cross sections, and those in the area from the roughly middle part to the outer side have rectangular cross sections.

In upper crushing panel 110, segments 110-1, 110-4, 110-7, 110-10; segments 110-2, 110-5, 110-8, 110-11; and segments 110-3, 110-6, 110-9, 110-12 each have crushing blades of the same shape. In the segments of upper crushing panel 110, the crushing blades in the areas on the inner side (the areas included in first crushing blade face 110a of FIG. 4) are formed by parallel grooves having saw-toothed cross sections, and those in the areas on the outer side are formed by parallel grooves having rectangular cross sections.

Thus, crushing blades having saw-toothed cross sections are formed in the areas on the side of charging port 18 of the opposing blade faces; therefore, the material to be crushed on the charging port side is efficiently sheared and guided to the area of second crushing blade face 100b. Although the space is narrower in the areas of second crushing blade face 100b than in the area of first crushing blade face 100a, the material to be crushed that has been sheared by saw-toothed blades easily goes into the narrow space, and, as a result, crushing is promoted.

In the area of second crushing blade face 100b, the crushing blades may have saw-toothed cross sections. In this case, however, the cross-sectional area of the space formed by the crushing blade crushing blades having saw-toothed cross sections is smaller than that formed by the crushing blades of the same groove depth having rectangular cross sections. As a result, the amount of processing decreases. The groove depth of a crushing blade is determined by the desired final particle diameter of the material to be crushed. In order to secure the required amount of processing, it is preferable that the crushing blades of second crushing blade face 100b and its opposing lower crushing blade face 110a have rectangular cross sections. In the example shown here, the maximum groove depth of the crushing blades having saw-toothed cross sections is 0.7 mm, and the maximum groove depth of the crushing blades having rectangular cross sections is 0.5 mm.

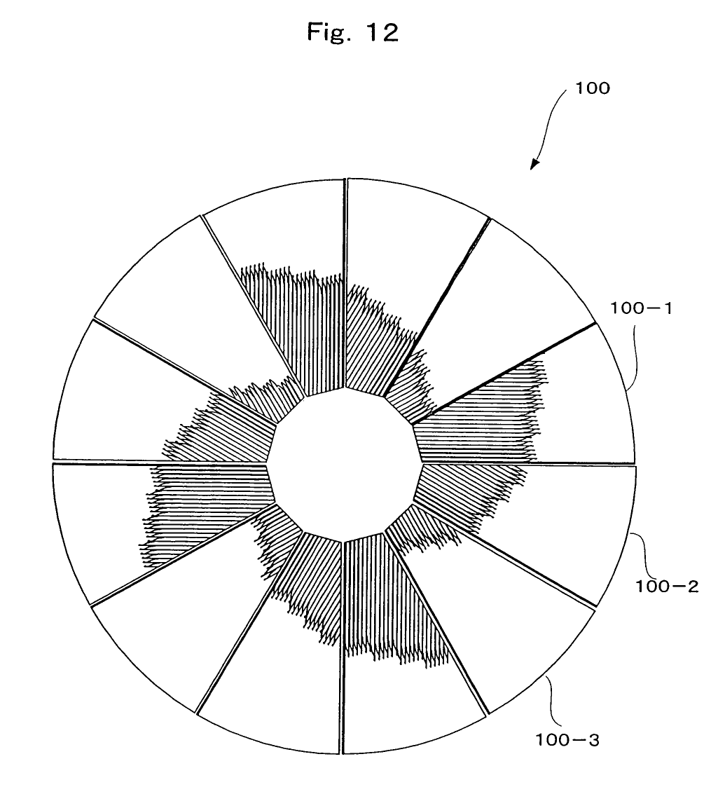

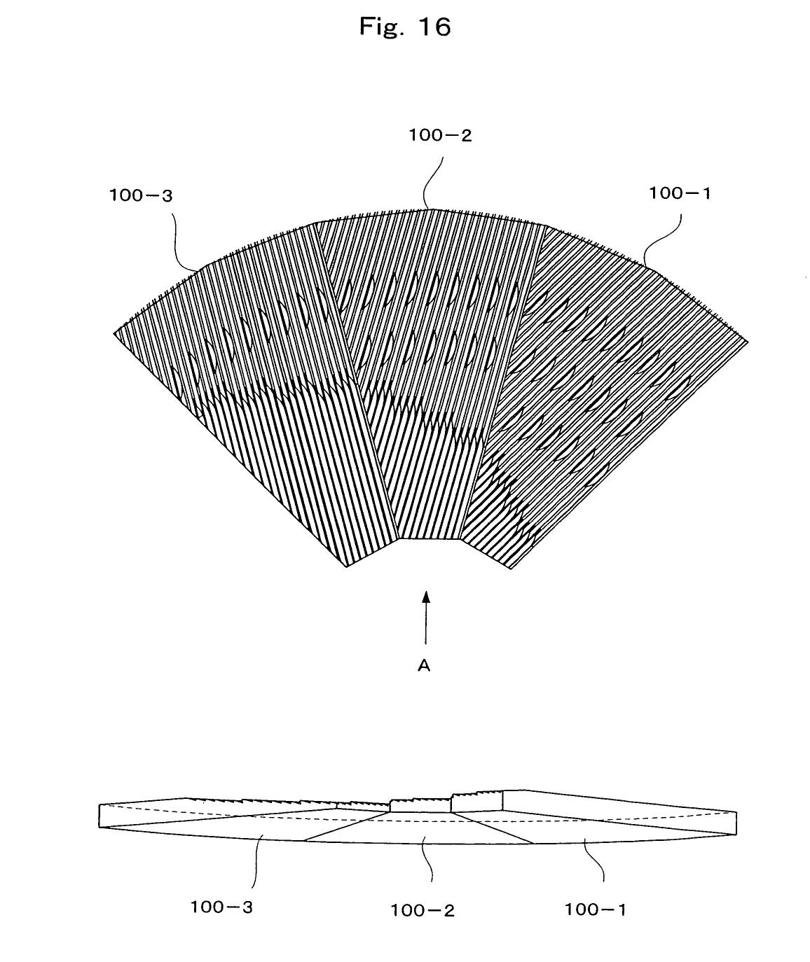

Furthermore, in the third embodiment, as shown in FIG. 12 (a plan view of an upper crushing panel, the rectangular blades not being shown for description) and FIG. 16, a group of three segments (for example, 100-1 to 100-3) is formed in a pattern such that the areas of the crushing blades having saw-toothed cross sections become gradually smaller in the direction of the circumference of upper crushing panel 100. The crushing blades formed in such a pattern enhance shearing capacity at the boundary between the crushing blades having saw-toothed cross sections and the crushing blades having rectangular cross sections, thus improving crushing efficiency.

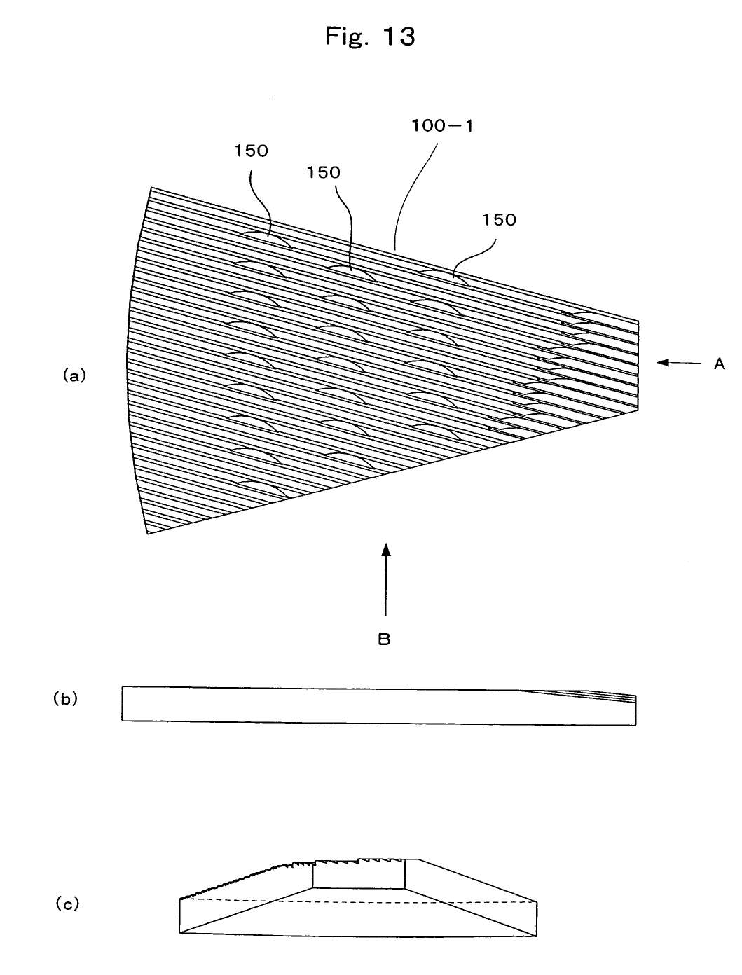

FIGS. 13 to 15 show enlarged views of segments 100-1, 100-2, and 100-3 respectively, with (a) being a plan view, (b) being a side view seen in the direction of B, and (c) being an A-A enlarged sectional view. As shown in FIGS. 13 (b), 14 (b), and 15 (b), in each segment, the height of crushing blades having saw-toothed cross sections is changed such that the gap between these crushing blades and lower crushing blade face 110a narrows in stages (or gradually) toward the circumference of the crushing panels. Such a structure achieves the effect of crushing the material to be crushed gradually to a small size.

Furthermore, in such a structure, since the gap gradually narrows in the direction of rotation, the level difference produced between adjacent segments exerts shearing force on the material to be crushed, thus improving crushing efficiency.

In the third embodiment, second crushing blade face 100b is substantially parallel to lower crushing blade face 110a, with the gap between the blade faces being about 0.1 mm.

As is clear from FIG. 11 and FIGS. 13 to 15, deep groove part 150 is formed in a concentric circular configuration on second crushing blade face 100b and its opposing lower crushing blade face 110a. As shown in FIG. 11 (c) as an enlarged sectional view, deep groove part 150 is formed by pocketlike grooves somewhat deeper than the rectangular grooves. When the material to be crushed is crushed by the upper and lower crushing panels and guided toward the circumference of the panels via the parallel grooves forming crushing blades, deep groove part 150 has the function of stirring the material in order to prevent the material from staying in the parallel grooves.

In the above-mentioned example, crushing is carried out by rotating only one crushing panel with the other crushing panel being fixed. However, the present invention is not limited to this. Both crushing panels may be designed to rotate in mutually different directions.

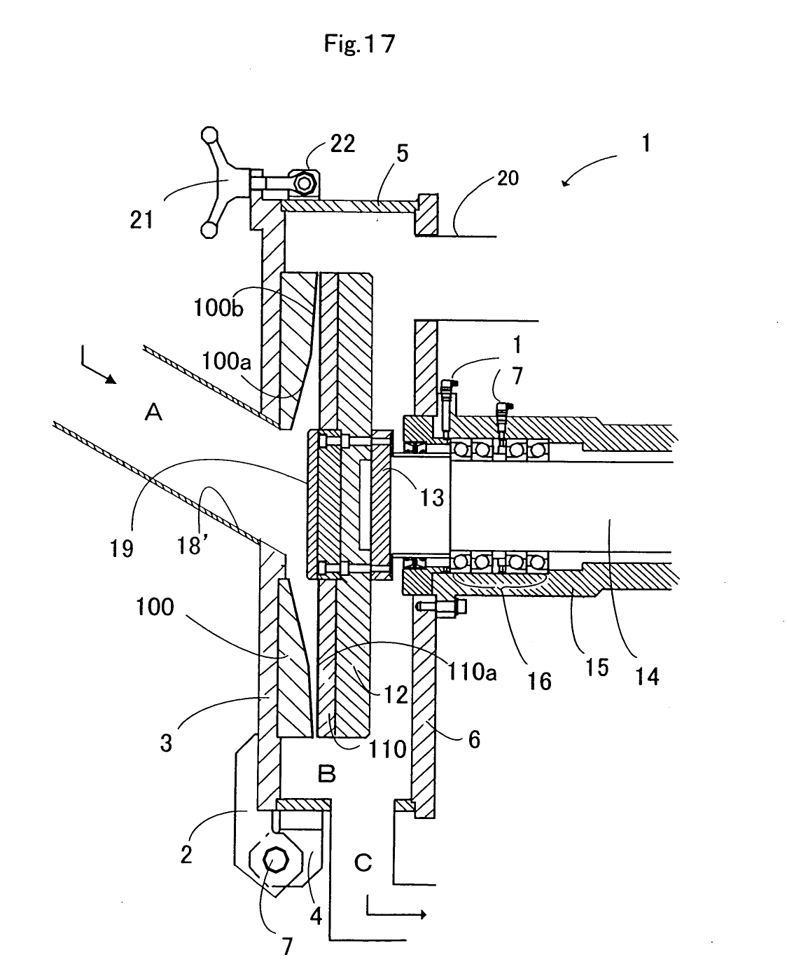

As in the fourth embodiment shown in FIG. 17, the crusher of the present invention may be used with first crushing panel 102 and second crushing panel 112 standing in the vertical direction. In this case, it is preferable that charging port 18′ for material to be crushed be positioned in the lateral direction of first crushing panel 101, and that discharge part 20′ be positioned in the lower part of the crusher (by forming an opening in case 5, etc.). This provides the advantages of making it easy to open and close first cover 3′ and making a balance weight or the like unnecessary as well as facilitating the transmission of power from a motor (not shown) to rotating shaft 14.

As described above, the crusher of the present invention is capable of crushing elastic materials to be crushed such as rubber, etc. to the desired size by minimizing the deformation of the materials that occurs at the time of crushing.

1. A crusher comprising
a pair of crushing panels, each crushing panel having crushing blades on the face opposing the other crushing panel;
a charging port for charging material to be crushed into a space where the crushing panels oppose each other, the charging port being formed near the center of one of the crushing panels; and
a driving part for rotating at least one of the crushing panels;
wherein the crushing blades are formed such that the material is crushed and pushed from the crushing panels by rotation of at least one of the crushing panels; and the angle formed by the pair of the crushing panels is smaller on the circumference side of the opposing faces of the crushing panels than on the central side of the opposing faces of the crushing panels.

2. A crusher according to claim 1, wherein the angle formed by the pair of the crushing panels is smaller on the circumference side of the opposing faces of the crushing panels than on the central side of the opposing faces of the crushing panels, in that, based on a concentric circular boundary formed on the opposing faces of the crushing panels, the above angle is smaller on the outer side of the boundary than on the inner side of the boundary.

3. A crusher according to claim 2, wherein, for at least one of the crushing panels, the number of crushing blades differs between the inner side and the outer side of the concentric circular boundary formed on the opposing faces of the crushing panels.

4. A crusher according to claim 2, wherein, on the outer side of the boundary, the opposing faces of the pair of the crushing panels are parallel to each other.

5. A crusher according to claim 1, wherein a passage for passing a cooling liquid is provided within at least one of the crushing panels.

6. A crusher according to claim 1, wherein the crushing blades on the opposing crushing panels are formed by parallel grooves such that the parallel grooves of the opposing crushing panels cross each other.

7. A crusher according to claim 6, wherein the parallel grooves of the crushing blades are formed in segments that equally divide the crushing panels.

8. A crusher according to claim 6, wherein the crushing blades comprise areas where the parallel grooves have rectangular cross sections and areas where the parallel grooves have saw-toothed cross sections, and the parallel grooves having saw-toothed cross sections are formed on the central side of the crushing panels.

9. A crusher according to claim 1, wherein, on the central side of the crushing panels, the crushing blades have heights such that the space between the opposing crushing panels gradually narrows toward the circumference of the crushing panels.

10. A crusher according to claim 8, wherein the parallel grooves having saw-toothed cross sections have heights such that the space between the opposing crushing panels gradually narrows toward the circumference of the crushing panels.

11. A crusher according to claim 6, wherein, on the central side of the crushing panels, the crushing blades have heights such that the space between the opposing crushing panels gradually narrows toward the circumference of the crushing panels.

12. A crusher according to claim 8, wherein, on the central side of the crushing panels, the crushing blades have heights such that the space between the opposing crushing panels gradually narrows toward the circumference of the crushing panels.
